(19) United States
(12) Patent Application Publication
(10) Pub. No.: US 2015/0262153 A1
(43) Pub. Date: Sep. 17, 2015

(54) TRANSPORTATION EXPENSE APPLYING SERVER, TRANSPORTATION EXPENSE APPLYING SYSTEM, TRANSPORTATION EXPENSE APPLYING METHOD, AND COMPUTER-READABLE RECORDING MEDIUM

(71) Applicant: NEC Corporation, Tokyo (JP)

(72) Inventor: Daiki KIKUNAGA, Tokyo (JP)

(21) Appl. No.: 14/644,876

(22) Filed: Mar. 11, 2015

(30) Foreign Application Priority Data
Mar. 11, 2014 (JP) 2014-047389

(51) Int. Cl. G06Q 20/14; G06Q 20/42; G06Q 30/04

(52) U.S. Cl. CPC G06Q 20/145; G06Q 30/04; G06Q 20/42

(57) ABSTRACT

Disclosed is a transportation expense applying system which makes it possible to efficiently apply for payment of transportation expenses incurred during traveling between business offices without cooperating with any apparatus installed in means of transportation.

In the transportation expense applying system, when a terminal has entered one of a plurality of specific places, the terminal transmits entrance information for identifying the entrance and the place the terminal has entered as well as terminal identification information to a transportation expense applying server, and when the terminal has exited one of the plurality of specific places, the terminal transmits exit information for identifying the exit and the place the terminal has exited as well as the terminal identification information to the transportation expense applying server. The transportation expense applying server includes a storage unit that stores the entrance information and the exit information relating to the terminal identification information received therewith.

This application is based upon and claims the benefit of priority from Japanese Patent Application No. 2014-047389, filed on Mar. 11, 2014, the disclosure of which is incorporated herein in its entirety by reference.

### TECHNICAL FIELD

The present invention relates to a transportation expense applying server, a transportation expense applying system, a transportation expense applying method, and a computer-readable recording medium.

### BACKGROUND ART

Generally, in a company, when a company member has traveled on company business (going out on business, a business trip, or the like) and transportation expenses have been incurred, the company member applies for payment of the transportation expenses with the company.

As an example of a method for applying for payment of such transportation expenses, there is a method in which the company member himself or herself applies for payment of the transportation expenses by inputting pieces of information, such as used means of transportation, a used transportation route, and transportation costs, into a computer system.

Such a method, however, imposes a heavy burden on the company member because the company member needs to calculate the transportation costs by himself or herself. Thus, recently, technologies, which make it possible to lighten a burden imposed on a company member who applies for payment of transportation expenses, have been proposed.

For example, in Patent Literature 1 (Japanese Patent Application Laid-Open No. 2004-280155), there is disclosed a technology in which a movement route and a movement speed of a company member are detected from histories of pieces of location information relating to a mobile terminal carried by the company member as well as pieces of clock time information; from detection results, means of transportation and a transportation route having been used by the company member are specified; and thereby transportation expenses are calculated.

Further, in each of Patent Literature 2 (Japanese Patent Application Laid-Open No. 2009-037289), Patent Literature 3 (Japanese Patent Application Laid-Open No. 2011-086137), and Patent Literature 4 (Japanese Patent Application Laid-Open No. 2011-118886), there is disclosed a technology in which, from actual usage histories acquired by cooperating with apparatuses installed in means of transportation, such as an automatic ticket gate and a ticket vending machine, transportation expense are calculated.

In a company having a plurality of business offices, company members move among the business offices very often. Thus, it is presumed that an application for payment of transportation expenses having been incurred in a movement between business offices is frequently made.

In this case, since a location of each of the business offices is already known, used means of transportation, a used transportation route, and transportation costs regarding a movement of a company member between business offices can be grasped by a company side to a certain degree.

In the technology disclosed in Patent Literature 1, even for just a movement between business offices, it is necessary to specify used means of transportation and a used transportation route by tracing the histories of pieces of location information relating to a mobile terminal as well as the pieces of clock time information, and thus, there is a problem in that it is difficult to efficiently apply for payment of transportation expenses.

Further, in the technology disclosed in each of Patent Literatures 2 to 4, there is a problem in that, in order to establish a system, it is necessary to cooperate with apparatuses installed in means of transportation.

### SUMMARY

The present invention has been made in order to solve the above problem. The present invention is intended to provide a technology which makes it possible to efficiently apply for payment of transportation expenses having been incurred in a movement between any two of predetermined places without cooperating with any apparatus installed in means of transportation.

(1) A transportation expense applying server of the present invention includes:

a communication unit that
receives entrance information including information for identifying that a terminal has entered one of a plurality of places, information for identifying a place the terminal has entered, and terminal identification information for identifying the terminal, and
receives exit information including information for identifying that the terminal has exited one of the plurality of places and information for identifying the place the terminal has exited, and the terminal identification information;

a storage unit that stores the entrance information and the exit information relating to the terminal identification information received therewith; and

a control unit that after storing the exit information, when storing the entrance information related to the terminal identification information which is identical to the terminal identification information related to the exit information,
refers to a transportation expense database which stores transportation expenses between/among the specific multiple locations, based on the entrance information and the exit information,
determines the transportation expenses between/among locations identified respectively by the entrance information and the exit information, and
sends a transportation expenses application notification applying for the determined transportation expenses to an accounting server.
   (2) A first transportation expense applying system of the present invention includes:

a terminal that is carriable by a user who travels between/among a plurality of specific places;

a transportation expense applying server that applies for transportation expenses occurred during the user's traveling between/among the plurality of specific places; and

an accounting server that is applied for the transportation expenses.

The terminal:
includes a place database in which locations each corresponding one of the plurality of places are registered,
acquires location information indicating a current location of the terminal,
determines whether or not the terminal has entered any one of the plurality of places as well as whether or not the terminal has exited any one of the plurality of places, by referring to the place database on the basis of the current location of the terminal,
transmits, in response to the terminal's entrance into one of the plurality of places, entrance information including information for identifying the entrance and information for identifying the place where the terminal has entered, and terminal identification information for identifying the terminal, to the transportation expense applying server, and
transmits, in response to the terminal's exit from one of the plurality of places, exit information including information for identifying the exit and information for identifying the place where the terminal has exited, and the terminal identification information, to the transportation expense applying server.

The transportation expense applying server:
includes a storage unit that stores therein the entrance information and the exit information received with the terminal identification information, in state that the entrance information and the exit information are related to the terminal identification information,
after storing the exit information, when storing the entrance information related to the terminal identification information which is identical to the terminal identification information related to the exit information, refers to a transportation expense database which stores transportation expenses between/among the specific multiple locations, based on the entrance information and the exit information,
determines the transportation expenses between/among locations identified respectively by the entrance information and the exit information, and
sends a transportation expenses application notification applying for the determined transportation expenses to an accounting server.
   (3) A second transportation expense applying system of the present invention includes:

a terminal that is carriable by a user who travels between/among a plurality of specific places;

a location information server;

a transportation expense applying server that applies for transportation expenses occurred during the user's traveling between/among the plurality of specific places; and

an accounting server that is applied for the transportation expenses.

The terminal:
acquires location information indicating a current location of the terminal, and
transmits the acquired location information and terminal identification information for identifying the terminal to the location information server.

The location information server:
includes a place database in which locations each corresponding one of the plurality of places are registered,
determines whether or not the terminal has entered any one of the plurality of places and whether or not the terminal has exited any one of the plurality of places, by referring to the place database on the basis of the current location of the terminal,
transmits, in response to the terminal's entrance into one of the plurality of places, entrance information including information for identifying the entrance and information for identifying the place where the terminal has entered, and terminal identification information for identifying the terminal, to the transportation expense applying server, and
transmits, in response to the terminal's exit from one of the plurality of places, exit information including information for identifying the exit and information for identifying the place where the terminal has exited, and the terminal identification information, to the transportation expense applying server.

The transportation expense applying server:
includes a storage unit that stores therein the entrance information and the exit information received with the terminal identification information, in state that the entrance information and the exit information are related to the terminal identification information,
after storing the exit information, when storing the entrance information related to the terminal identification information which is identical to the terminal identification information related to the exit information, refers to a transportation expense database which stores transportation expenses between/among the specific multiple locations, based on the entrance information and the exit information,
determines the transportation expenses between/among locations identified respectively by the entrance information and the exit information, and
sends a transportation expenses application notification applying for the determined transportation expenses to an accounting server.
   (4) A transportation expense applying method of the present invention performed by a transportation expense applying server, includes:

receiving entrance information including information for identifying that a terminal has entered one of a plurality of specific places and information for identifying the place the terminal has entered, as well as terminal identification information for identifying the terminal;

storing the exit information relating to the terminal identification information received therewith;

receiving exit information including information for identifying that the terminal has exited one of the plurality of specific places and information for identifying the place the terminal has exited, as well as the terminal identification information;

storing the exit information relating to the terminal identification information received therewith;

after storing the exit information, when storing the entrance information related to the terminal identification information which is identical to the terminal identification information related to the exit information, referring to a transportation expense database which stores transportation expenses between/among the specific multiple locations, based on the entrance information and the exit information,

determining the transportation expenses between/among locations identified respectively by the entrance information and the exit information, and

sending a transportation expenses application notification applying for the determined transportation expenses to external.

(5) A computer-readable non-temporary recording medium of the present invention that stores therein a program which causes a computer to execute processing, the processing includes:

receiving entrance information including information for identifying that a terminal has entered one of a plurality of specific places and information for identifying the place the terminal has entered, as well as terminal identification information for identifying the terminal;

storing the exit information relating to the terminal identification information received therewith;

receiving exit information including information for identifying that the terminal has exited one of the plurality of specific places and information for identifying the place the terminal has exited, as well as the terminal identification information;

storing the exit information relating to the terminal identification information received therewith;

after storing the exit information, when storing the entrance information related to the terminal identification information which is identical to the terminal identification information related to the exit information, referring to a transportation expense database which stores transportation expenses between/among the specific multiple locations, based on the entrance information and the exit information;

determining the transportation expenses between/among locations identified respectively by the entrance information and the exit information; and

sending a transportation expenses application notification applying for the determined transportation expenses to external.

According to the aspects of the present invention, it becomes possible to efficiently apply for payment of transportation expenses having been incurred in a movement between any two of predetermined places without cooperating with any apparatus installed in means of transportation.

### BRIEF DESCRIPTION OF THE DRAWINGS

Exemplary features and advantages of the present invention will become apparent from the following detailed description when taken with the accompanying drawings in which:

FIG. 1 is a diagram illustrating an example of a configuration of a transportation expense applying system in a first exemplary embodiment of the present invention,

FIG. 2 is block diagram illustrating an example of a configuration of a terminal in a first exemplary embodiment of the present invention,

FIG. 3 is a diagram illustrating an example of a business office database of first and second exemplary embodiments of the present invention,

FIG. 4 is block diagram illustrating an example of a configuration of a transportation expense applying server of first and second exemplary embodiments of the present invention,

FIG. 5 is a diagram illustrating an example of a terminal database of first and second exemplary embodiments of the present invention,

FIG. 6 is a diagram illustrating an example of a transportation expense database of first and second exemplary embodiments of the present invention,

FIG. 7 is a diagram illustrating an example of a state in which exit information is stored in a temporary storage unit of first and second exemplary embodiments of the present invention,

FIG. 8 is a diagram illustrating an example of a state in which exit information and entrance information are stored in a temporary storage unit of first and second exemplary embodiments of the present invention,

FIG. 9 is sequence diagram illustrating an example of operation of a transportation expense applying system of the first exemplary embodiment of the present invention,

FIG. 10 is a diagram illustrating an example of a configuration of a transportation expense applying system of a second exemplary embodiment of the present invention,

FIG. 11 is block diagram illustrating an example of a configuration of a terminal of a second exemplary embodiment of the present invention,

FIG. 12 is block diagram illustrating an example of a configuration of a location information server of a second exemplary embodiment of the present invention,

FIG. 13 is sequence diagram illustrating an example of operation of a transportation expense applying system of a second exemplary embodiment of the present invention, and

FIG. 14 is a diagram illustrating an example of a configuration of a transportation expense applying server in a third exemplary embodiment of the present invention.

### EXEMPLARY EMBODIMENT

Next, a detailed explanation will be given for exemplary embodiments with reference to the drawings. In addition, in all drawings described below, identical constituent elements are each denoted by the same reference sign and a duplicated explanation thereof will be omitted appropriately.

### First Exemplary Embodiment

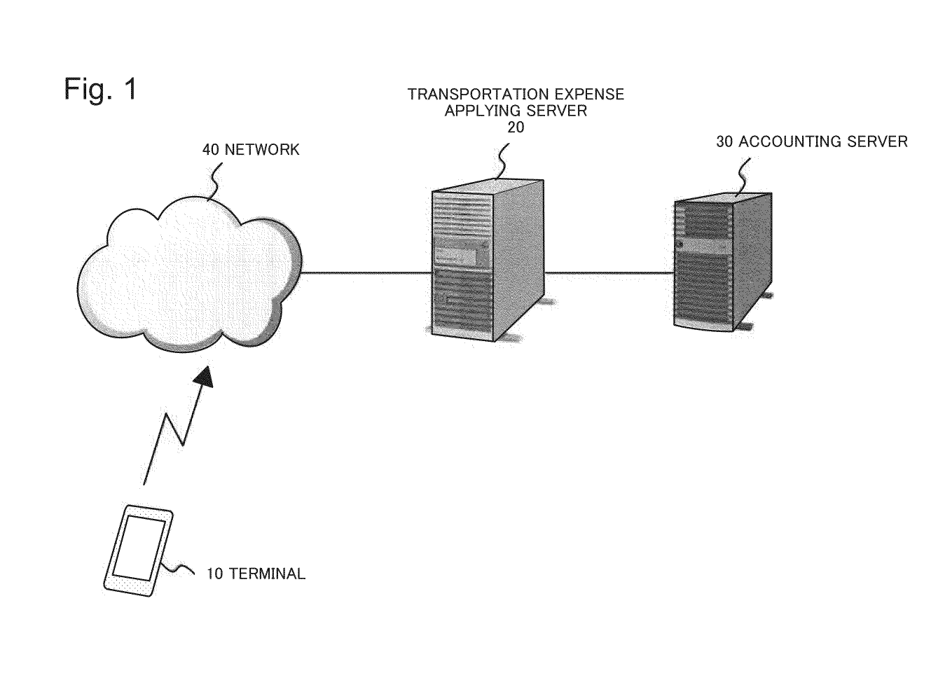

FIG. 1 illustrates an example of a configuration of a transportation expense applying system in a first exemplary embodiment of the present invention.

A transportation expense applying system of this exemplary embodiment is installed in a company having a plurality of business offices, and is used for applying for payment of transportation expenses having been incurred in each company member's movement (traveling) among any, at least, two of the business offices. In the following embodiments, to briefly describe the process, it is assumed that a user travels between two of the business offices.

As shown in FIG. 1, the transportation expense applying system of this exemplary embodiment includes a terminal 10, a transportation expense applying server 20, and an accounting server 30. In addition, in FIG. 1, for the sake of convenience of description, only one terminal 10 is illustrated, but it is supposed that, actually, a plurality of terminals 10 is provided.

The transportation expense applying server 20 is disposed on a network (a communication network) 40 which is the Internet or the like.

The terminal 10 becomes capable of communicating with the transportation expense applying server 20 disposed on the network 40 by making an access to the network 40 via a mobile communication network (not illustrated) or the like.

The transportation expense applying server 20 and the accounting server 30 are communicably connected to each other via an in-company local area network (LAN) (not illustrated) or the like.

The terminal 10 is a terminal carried by a company member who moves between business offices.

The transportation expense applying server 20 is a server which applies for payment of transportation expenses having been incurred in each company member's movement between business offices.

The accounting server 30 is a server which is a destination of the application for payment of transportation expenses.

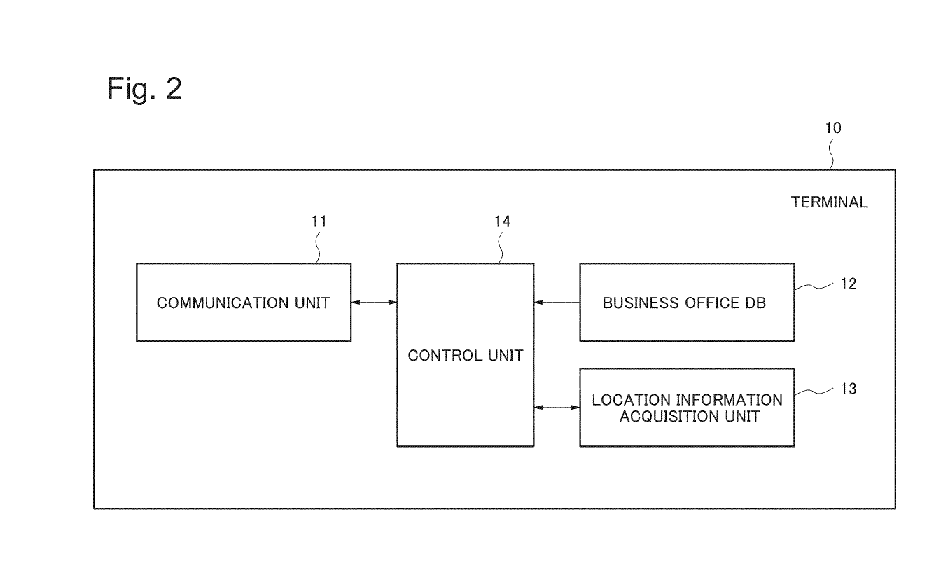

FIG. 2 illustrates an example of a configuration of the terminal 10 of this exemplary embodiment.

As shown in FIG. 2, the terminal 10 of this exemplary embodiment includes a communication unit 11, a business office database (hereinafter, this database will be referred to as a DB) 12, a location information acquisition unit 13, and a control unit 14.

The communication unit 11 serves as a communication interface with external devices.

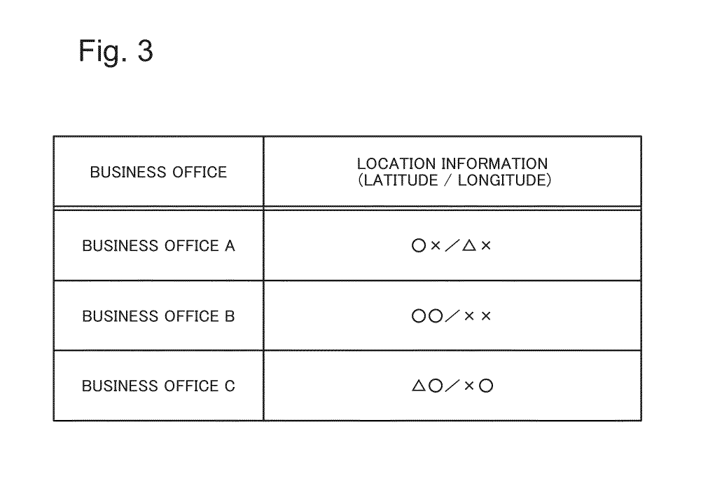

As shown in FIG. 3, the business office DB 12 is database in which pieces of location information each indicating a location of a corresponding one of the plurality of business offices are registered in advance. This business office DB 12 is an example of the place database. In addition, in FIG. 3, a piece of location information indicating a location of a business office is information indicating a latitude value and a longitude value, but the present invention is not limited to this kind of information.

The location information acquisition unit 13 has a location information acquisition function (for example, a global positioning system (GPS) function) to acquire location information indicating a current location of the terminal 10.

When, as a result of referring to the business office DB 12 on the basis of current location information relating to the terminal 10, having been acquired by the location information acquisition unit 13, the current location of the terminal 10 is positioned within a predetermined range from a location of a certain business offices, the control unit 14 determines that the terminal 10 is currently positioned inside the business office.

Through the use of this mechanism, when the terminal 10 has gone into a predetermined range from a location of a certain one of the business offices, the control unit 14 determines that the terminal 10 has entered the business office, and when the terminal 10 has gone out from the predetermined range, the control unit 14 determines that the terminal 10 has exited the certain one of the business offices.

When having determined that the terminal 10 has exited any one of the certain business offices, the control unit 14 transmits a piece of exit information as well as a piece of terminal identification information for identifying the terminal 10 to the transportation expense applying server 20. The exit information includes information for identifying an exit, a piece of business office identification information for identifying a business office the terminal 10 has exited, and a piece of clock time information.

Further, when having determined that the terminal 10 has entered any one of the business offices, the control unit 14 transmits a piece of entrance information as well as the terminal identification information for identifying the terminal 10 to the transportation expense applying server 20. The entrance information includes information for identifying an entrance, business office identification information for identifying a business office the terminal 10 has entered, and clock time information.

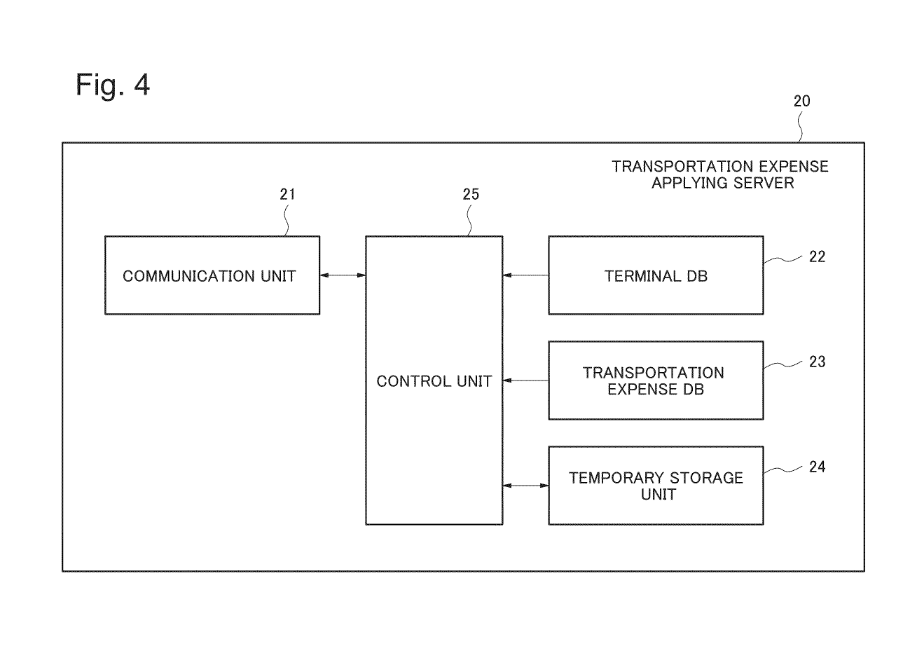

FIG. 4 illustrates an example of a configuration of the transportation expense applying server 20 of this exemplary embodiment.

As shown in FIG. 4, the transportation expense applying server 20 of this exemplary embodiment includes a communication unit 21, a terminal DB 22, a transportation expense DB 23, a temporary storage unit 24, and a control unit 25.

The communication unit 21 serves as a communication interface with external devices.

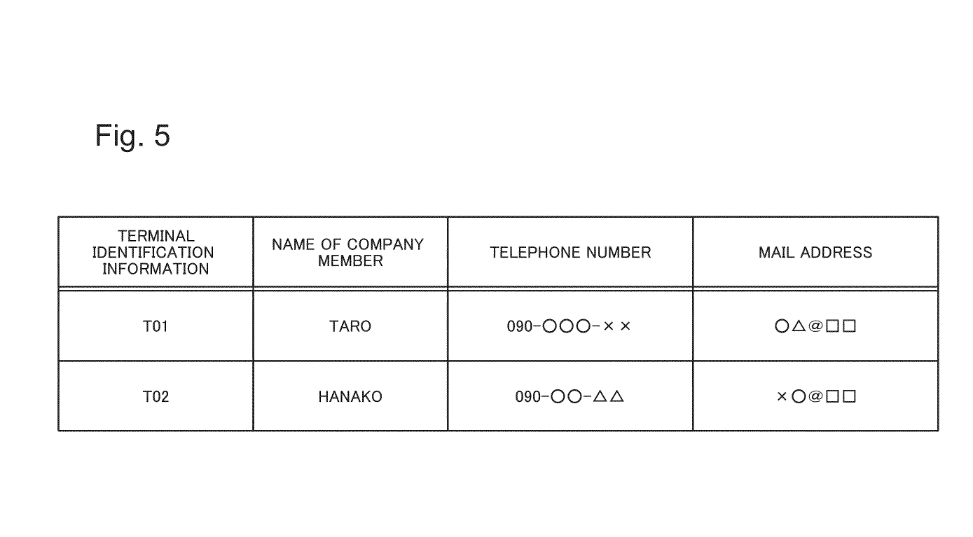

As shown in FIG. 5, the terminal DB 22 is a database in which pieces of information, which relate to the terminal 10 and a company member who carries the terminal 10 and which are related to one of the pieces of terminal identification information each for identifying a corresponding one of the terminals 10, are registered in advance. In addition, in FIG. 5, it is supposed that, as the terminal identification information, an international mobile equipment identity (IMEI), an international mobile subscriber identity (IMSI) or the like is used. Further, in FIG. 5, in the terminal DB 22, pieces of information, each indicating a corresponding one of a name of a company member who carries the terminal 10, a telephone number of the terminal 10, and a mail address of the terminal 10, are registered so as to be related to one another.

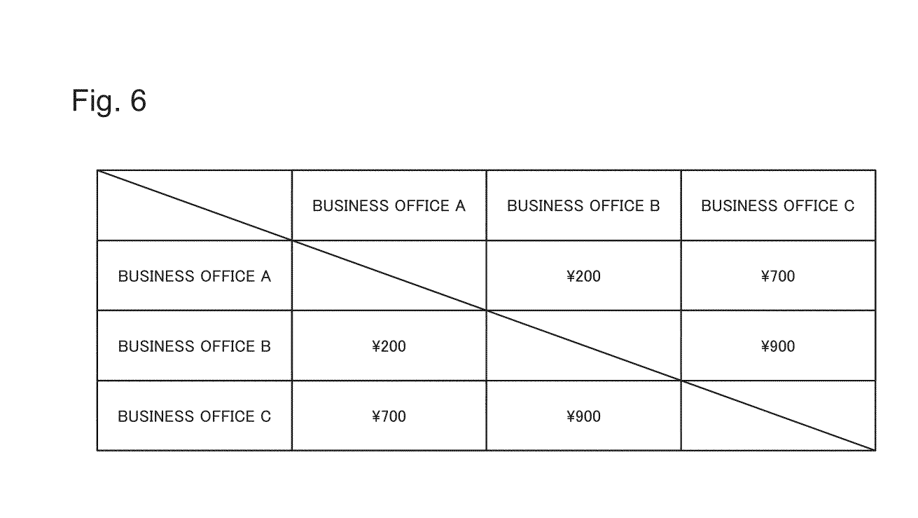

As shown in FIG. 6, the transportation expense DB 23 is a database in which pieces of information each associated with transportation expenses between corresponding two of the business offices are registered in advance.

The temporary storage unit 24 temporarily stores therein a received set of entrance information together with terminal identification information for identifying a terminal 10 as well as a received set of exit information together with terminal identification information for identifying a terminal 10.

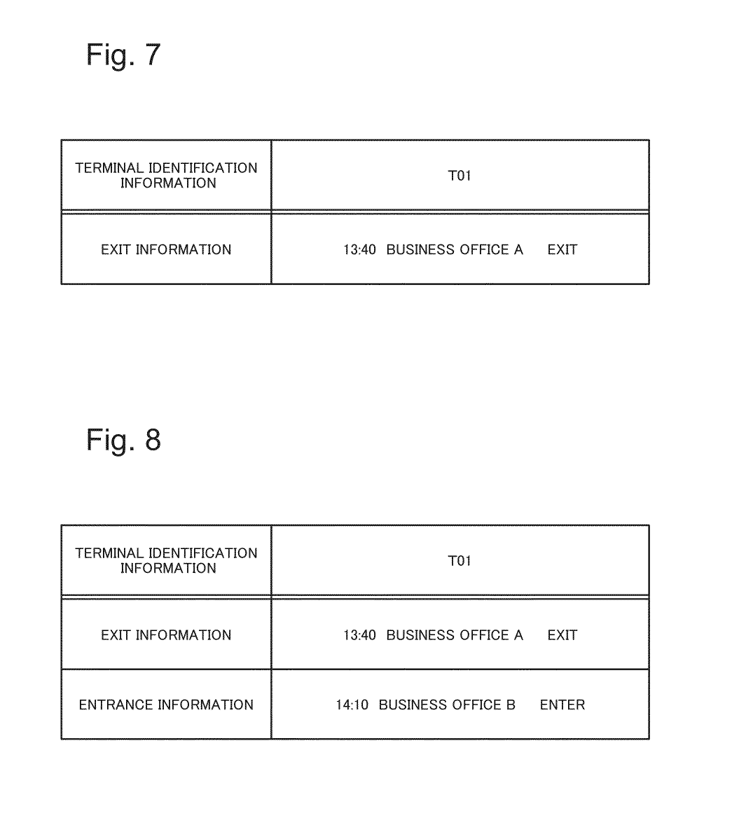

When having received exit information and terminal identification information from a terminal 10, for example, as shown in FIG. 7, the control unit 25 temporarily stores the exit information and the terminal identification information into the temporary storage unit 24 such that these two kinds of information are related to each other.

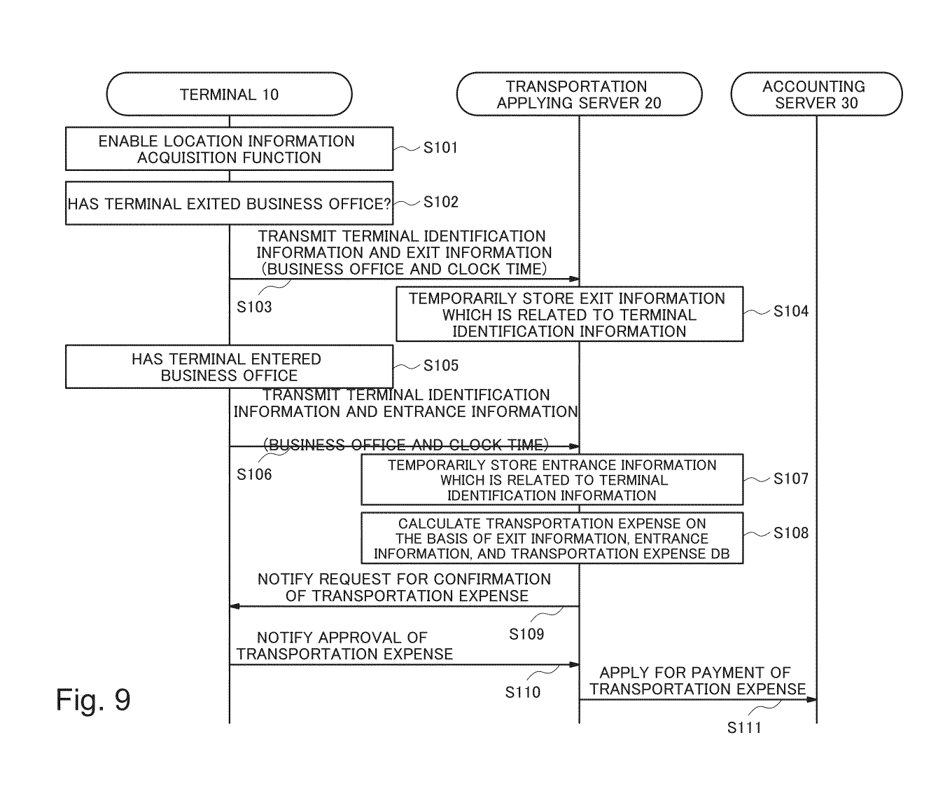

Further, when having received entrance information and terminal identification information from a terminal 10, for example, as shown in FIG. 8, the control unit 25 temporarily stores the entrance information and the terminal identification information into the temporary storage unit 24 such that these two kinds of information are related to each other.

Here, it is supposed that, after having stored exit information, the control unit 25 has stored entrance information which is related to the same piece of terminal identification information as that related to the exit information (a state shown in FIG. 8). In this case, by referring to the transportation expense DB 23 on the basis of the exit information and the entrance information, the control unit 25 determines transportation expenses between two business offices which are identified on the basis of the exit information and the entrance information.

After the determination of the transportation expense, the control unit 25 transmits, to the terminal 10, a transportation expense confirmation request notification TN for requesting a confirmation of the determined transportation expenses. The transportation expense confirmation request notification TN includes information indicating transportation expenses, as well as exit information and entrance information which have been used for the determination of the transportation expenses.

When having received, from the terminal 10, a transportation expense approval notification for notifying an approval of the transportation expenses, the control unit 25 transmits a transportation expense application notification for applying for payment of the transportation expenses to the accounting server 30.

When having received the transportation expense application notification from the transportation expense applying server 20, the accounting server 30 settles the transportation expenses. In addition, a settlement process of settling transportation expenses, performed by the accounting server 30, is not an essential portion of the present invention, and thus, an appropriate one of various publicly known technologies for the settlement process can be utilized. For this reason, detailed description of a configuration and operation of the accounting server 30 is omitted here.

Hereinafter, operation of a transportation expense applying system of this exemplary embodiment will be described.

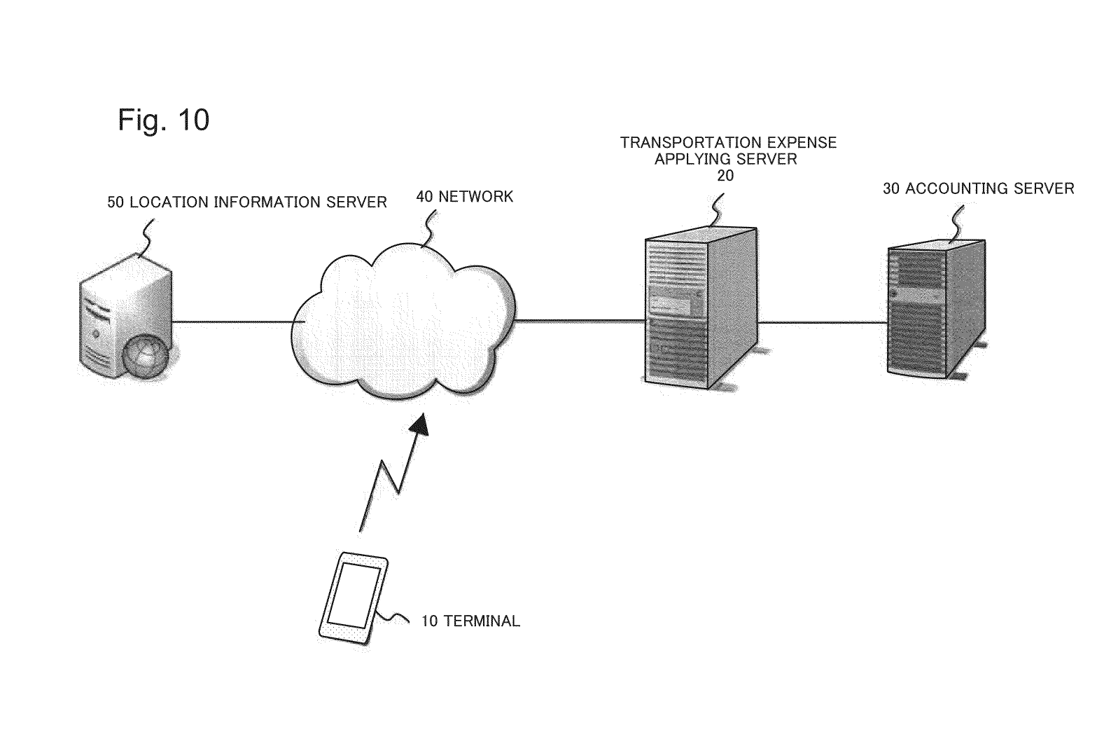

FIG. 9 illustrates an example of operation of the transportation expense applying system of this exemplary embodiment.

It is supposed that, in step S101, in a terminal 10, a location information acquisition function of the location information acquisition unit 13 is enabled in advance (refer to FIG. 9).

Thereafter, the control unit 14 of the terminal 10 refers to the business office DB 12 on the basis of location information indicating a current location of the terminal 10, having been acquired by the location information acquisition unit 13. Through this reference, the control unit 14 determines whether or not the terminal 10 has exited any one of the business offices as well as whether or not the terminal 10 has entered any one of the business offices.

In step S102, the control unit 14 of terminal 10 determines that the terminal 10 has exited one of the business offices. In this case, in step S103, the control unit 14 transmits exit information and terminal identification information for identifying the terminal 10 to the transportation expense applying server 20. The exit information includes information for identifying the exit, business office identification information for identifying the business office the terminal 10 has exited, and clock time information.

In step S104, when having received, from the terminal 10, the exit information and the terminal identification information, the control unit 25 of the transportation expense applying server 20 temporarily stores the exit information relating to the terminal 10 and the terminal identification information indicating the terminal 10 into the temporary storage unit 24 such that these two kinds of information are related to each other.

In step S105, the control unit 14 of the terminal 10 determines that the terminal 10 has entered one of the business offices. In this case, in step S106, the control unit 14 transmits entrance information and terminal identification information for identifying the terminal 10 to the transportation expense applying server 20. The entrance information includes information for identifying the entrance, business office identification information for identifying the business office the terminal 10 has entered, and clock time information.

In step S107, when having received, from the terminal 10, the entrance information and the terminal identification information, the control unit 25 of the transportation expense applying server 20 temporarily stores the entrance information relating to the terminal 10 and the terminal identification information indicating the terminal 10 into the temporary storage unit 24 such that these two kinds of information are related to each other.

It is supposed here that, as a result, for example, entrance information which is related to the same piece of terminal identification information as that related to the already stored set of exit information has been stored in temporary storage unit 24 of the transportation expense applying server 20.

In this case, in step S108, the control unit 25 of the transportation expense applying server 20 refers to the transportation expense DB 23 on the basis of the entrance information and the exit information which are related to the same piece of terminal identification information. As a result of the reference, the control unit 25 determines transportation expenses between two of the business offices, which are identified on the basis of the entrance information and the exit information.

In step S109, the control unit 25 of the transportation expense applying server 20 refers to the terminal DB 22 on the basis of the terminal identification information indicating the terminal 10, and thereby extracts a mail address of the terminal 10. Further, the control unit 25 transmits a transportation expense confirmation request notification TN for requesting a confirmation of the determined transportation expenses, to the mail address of the terminal 10. The transportation expense confirmation request notification TN includes information indicating the transportation expenses as well as the exit information and the entrance information which have been used for the determination of the transportation expenses.

In step S110, the control unit 14 of the terminal 10 receives the transportation expense confirmation request notification TN from the transportation expense applying server 20. The control unit 14 presents the information indicating the transportation expenses, the exit information, and the entrance information, which are included in the received transportation expense confirmation request notification TN, on a display unit (not illustrated) of the terminal 10, and thereby requests a company member who carries the terminal 10 to approve the transportation expenses. When the company member performs operation of approving the transportation expenses via an operation unit (not illustrated) of the terminal 10, the control unit 14 of the terminal 10 transmits a transportation expense approval notification for notifying an approval of the transportation expenses, to the transportation expense applying server 20.

In step S111, when having received the transportation expense approval notification from the terminal 10, the control unit 25 of the transportation expense applying server 20 transmits a transportation expense application notification for applying for payment of the transportation expenses with the accounting server 30. Upon reception of this notification, the accounting server 30 settles the transportation expenses.

In addition, it is supposed that, thereafter, the exit information and the entrance information which have been used for the determination of the transportation expenses are deleted from the temporary storage unit 24. In addition, a timing point of the deletion may be optionally determined as far as the timing point of the deletion is a timing point after the reception of the transportation expense approval notification in step S110, such as a timing point after the transmission of the transportation expense application notification in Step S111.

Further, naturally, it is also assumed that, in the temporary storage unit 24, before exit information is stored, entrance information is stored. In such a case, however, the entrance information is not information indicating an entrance after a movement between business offices, and thus, the entrance information is not used for any determination of transportation expenses. Thus, the entrance information is deleted from the temporary storage unit 24 at an optional timing point.

As described above, in this exemplary embodiment, the transportation expense applying server 20 registers transportation expenses between every two of the business offices in the transportation expense DB 23 in advance. It is supposed that, after having stored exit information relating to a business office, the transportation expense applying server 20 stores entrance information relating to a different business office such that the entrance information is related to the same piece of terminal identification information as that related to the exit information. In this case, through reference to the transportation expense DB 23, the transportation expense applying server 20 determines transportation expense between two business offices which are identified on the basis of the entrance information and the exit information, and applies for payment of the determined transportation expenses with the accounting server 30.

Thus, a user (such as a company member) of the terminal 10 can efficiently apply for payment of transportation expenses having been incurred in a movement of the user between business offices without cooperating with any apparatus installed in means of transportation.

Further, when having determined transportation expenses, the transportation expense applying server 20 transmits a request for a confirmation of the transportation expenses to the terminal 10, and after the confirmation of the transportation expenses, the transportation expense applying server 20 applies for payment of the transportation expenses with the accounting server 30.

Thus, according to this exemplary embodiment, it becomes possible to prevent any improper application for payment of transportation expenses as well as any omission of applying for payment of transportation expenses.

### Second Exemplary Embodiment

In the first exemplary embodiment, the terminal 10 itself determines its entrance into a business office as well as its exit from a business office on the basis of pieces of current location information relating to the terminal 10 itself.

In contrast, in this second exemplary embodiment of the present invention, a terminal 10 performs only transmission of pieces of current location information relating to the terminal 10 itself, and at the network 40 side, it is determined whether or not the terminal 10 has exited any one of the business offices as well whether or not the terminal 10 has entered any one of the business offices.

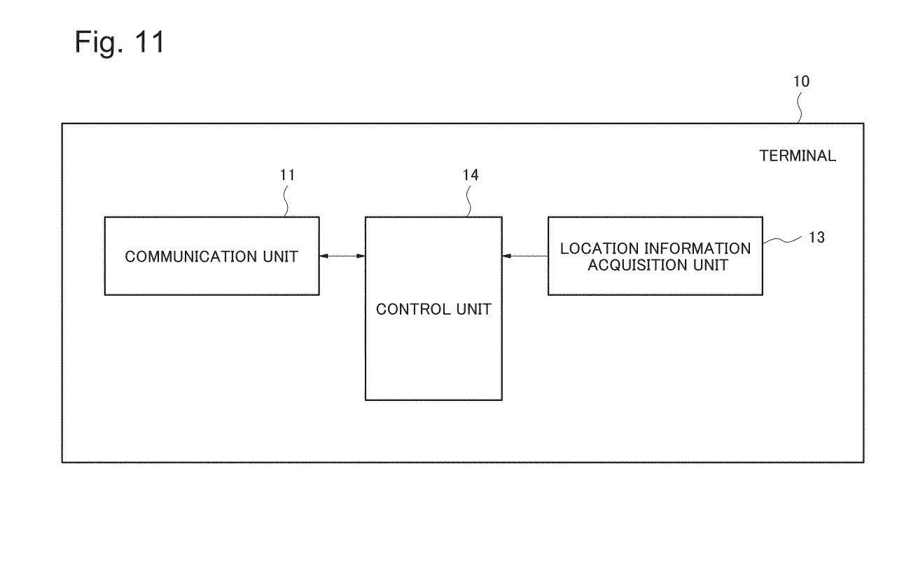

FIG. 10 illustrates an example of a configuration of a transportation expense applying system of this second exemplary embodiment of the present invention.

As shown in FIG. 10, a transportation expense applying system of this exemplary embodiment is different as compared with the transportation expense applying system of the first exemplary embodiment, shown in FIG. 1, in a respect that a location information server 50 is added.

The location information server 50 is disposed on the network 40, and determines whether or not the terminal 10 has exited any one of the business offices as well as whether or not the terminal 10 has entered any one of the business offices, on the basis of the pieces of current location information relating to the terminal 10.

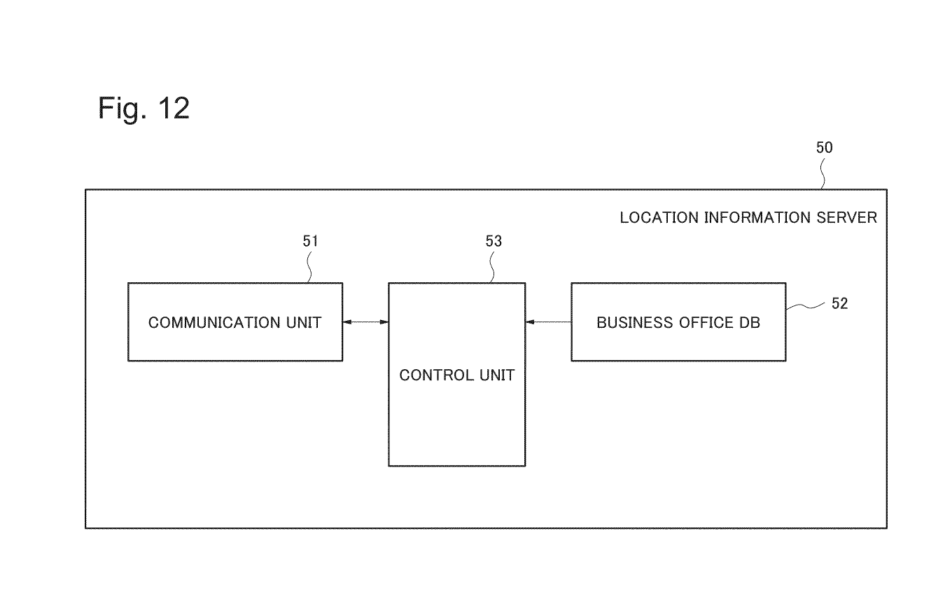

FIG. 11 illustrates an example of a configuration of the terminal 10 of this exemplary embodiment.

As shown in FIG. 11, the terminal 10 of this exemplary embodiment is different as compared with that of the first exemplary embodiment, shown in FIG. 2, in a respect that the business office DB 12 is not included in the terminal 10 of this exemplary embodiment.

Different from the first exemplary embodiment, it is unnecessary for the control unit 14 to determine whether or not the terminal 10 has exited any one of the business offices as well as whether or not the terminal 10 has entered any one of the business offices. Thus, the control unit 14 transmits current location information relating to the terminal 10, having been acquired by the location information acquisition unit 13, and terminal identification indicating the terminal 10, to the location information server 50.

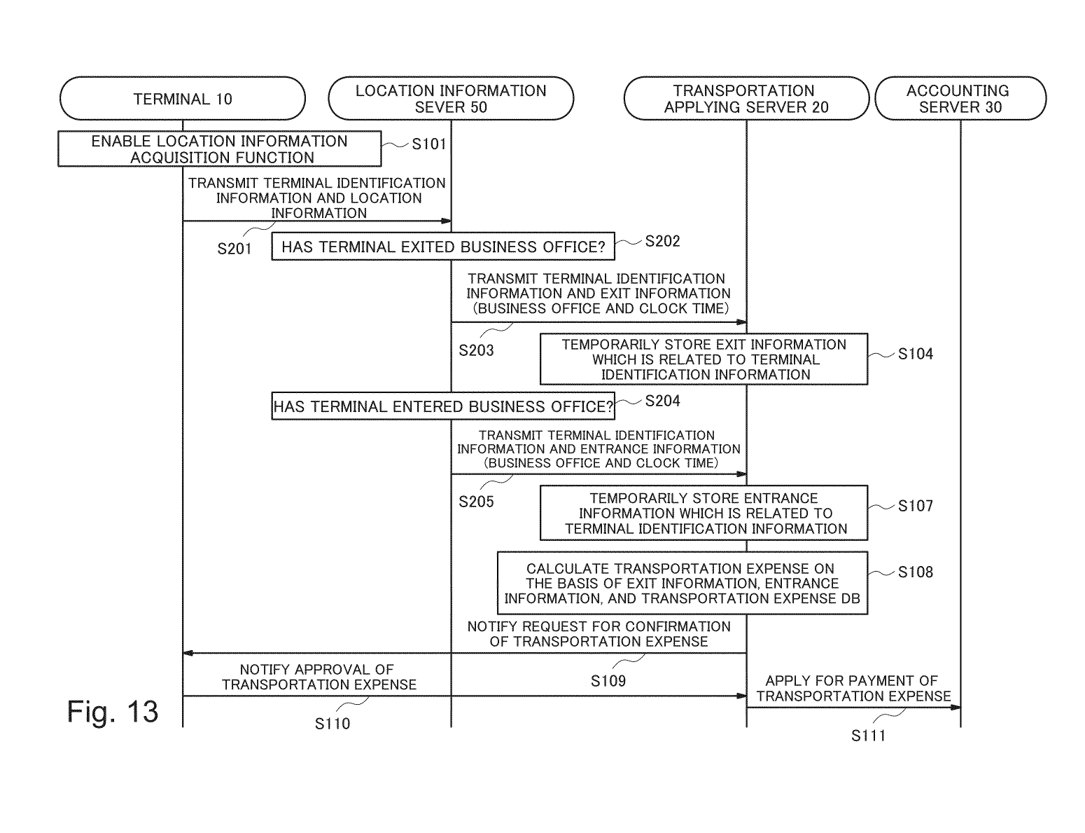

FIG. 12 illustrates an example of a configuration of the location information server 50 of this exemplary embodiment.

As shown in FIG. 12, the location information server 50 of this exemplary embodiment includes a communication unit 51, a business office DB 52, and a control unit 53.

The communication unit 51 is a communication interface with external devices.

The business office DB 52 is a database which has the same configuration as that of the business office DB 12 shown in FIG. 2, and in which, as shown in FIG. 3, pieces of location information, each indicating a location of a corresponding one of the plurality of business offices, are registered in advance.

The control unit 53 refers to the business office DB 52 on the basis of current location information having been received from the terminal 10, and thereby determines whether or not the terminal 10 has exited any one of the business offices as well as whether or not the terminal 10 has entered any one of the business offices. This determination can be made by employing a method similar to the method, shown in FIG. 2, performed by the control unit 14.

The control unit 53 determines that the terminal 10 has exited one of the business offices. In this case, the control unit 53 transmits exit information and terminal identification information for identifying the terminal 10 to the transportation expense applying server 20. The exit information includes information for identifying the exit, business office identification information for identifying the business office the terminal 10 has exited, and clock time information.

The control unit 53 determines that the terminal 10 has entered another one of the business offices. In this case, the control unit 53 transmits entrance information and terminal identification information for identifying the terminal 10 to the transportation expense applying server 20. The entrance information includes information for identifying the entrance, business office identification information for identifying the business office the terminal 10 has entered, and clock time information.

In this exemplary embodiment, a configuration other than the above-described configuration is the same as that of the first exemplary embodiment, and thus, description thereof is omitted here.

Hereinafter, operation of the transportation expense applying system of this exemplary embodiment will be described.

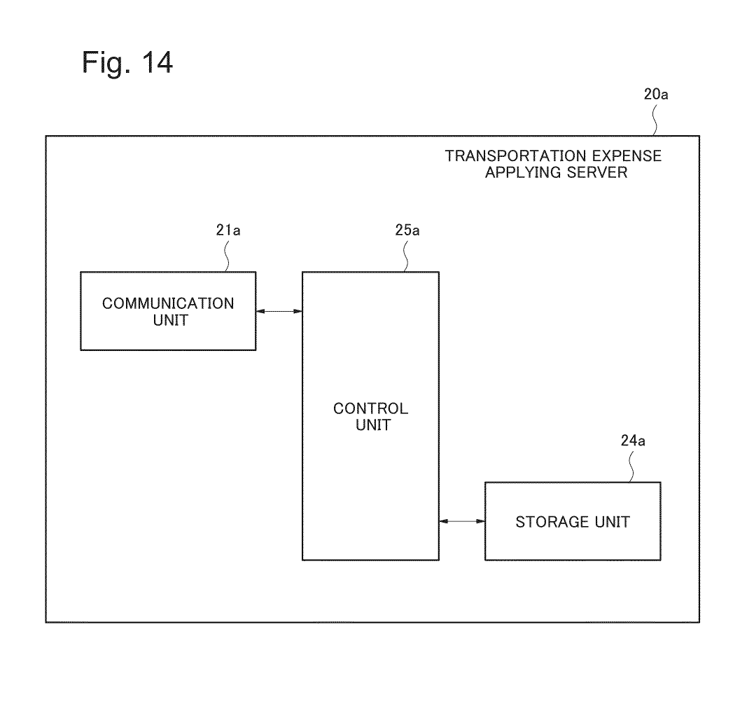

FIG. 13 illustrates an example of operation of the transportation expense applying system of this exemplary embodiment.

As shown in FIG. 13, in Step S101, the control unit 14 of the terminal 10 detects that the location information acquisition function of the location information acquisition unit 13 has been enabled. In step S201, the control unit 14 continually transmits current location information relating to the terminal 10, having been acquired by the location information acquisition unit 13, as well as terminal identification information for identifying the terminal 10, to the location information server 50. In addition, the transmission to the location information server 50 may be periodically performed, or may be performed every time the terminal 10 moves by a distance larger than or equal to a predetermined distance.

Thereafter, every time the control unit 53 of the location information server 50 receives current location information from the terminal 10, the control unit 53 refers to the business office DB 52 on the basis of the received piece of current location information relating to the terminal 10, and thereby the control unit 53 determines whether or not the terminal 10 has exited any one of the business offices as well as whether or not the terminal 10 has entered any one of the business offices.

In step S202, the control unit 53 of the location information server 50 determines that the terminal 10 has exited one of the business offices. In this case, in step S203, the control unit 53 transmits exit information and terminal identification information for identifying the terminal 10 to the transportation expense applying server 20. The exit information includes information for identifying the exit, business office identification information for identifying the business office the terminal 10 has exited, and clock time information.

In step S204, the control unit 53 of the location information server 50 determines that the terminal 10 has entered one of the business offices. In this case, in step S205, the control unit 53 transmits entrance information and terminal identification information for identifying the terminal 10 to the transportation expense applying server 20. The entrance information includes information for identifying the entrance, business office identification information for identifying the business office the terminal 10 has entered, and clock time information.

In this exemplary embodiment, operation other than the above-described operation is the same as that of the first exemplary embodiment, and thus description thereof is omitted here.

An advantageous effect of this exemplary embodiment is the same as that of the first exemplary embodiment. Through reference to the transportation expense DB 23, the transportation expense applying server 20 determines transportation expenses between two business offices which are identified on the basis of the entrance information and the exit information, and applies for payment of the determined transportation expenses with the accounting server 30. Thus, according to this exemplary embodiment, it becomes possible to efficiently apply for payment of transportation expenses having been incurred in a movement between business offices without cooperating with any apparatus installed in means of transportation.

Further, when having determined transportation expenses, the transportation expense applying server 20 transmits a request for a confirmation of the transportation expenses to the terminal 10, and after the confirmation of the transportation expenses, the transportation expense applying server 20 applies for payment of the transportation expenses with the accounting server 30. Thus, according to this exemplary embodiment, it becomes possible to prevent any improper application for payment of transportation expenses as well as any omission of applying payment of transportation expenses.

### Third Exemplary Embodiment

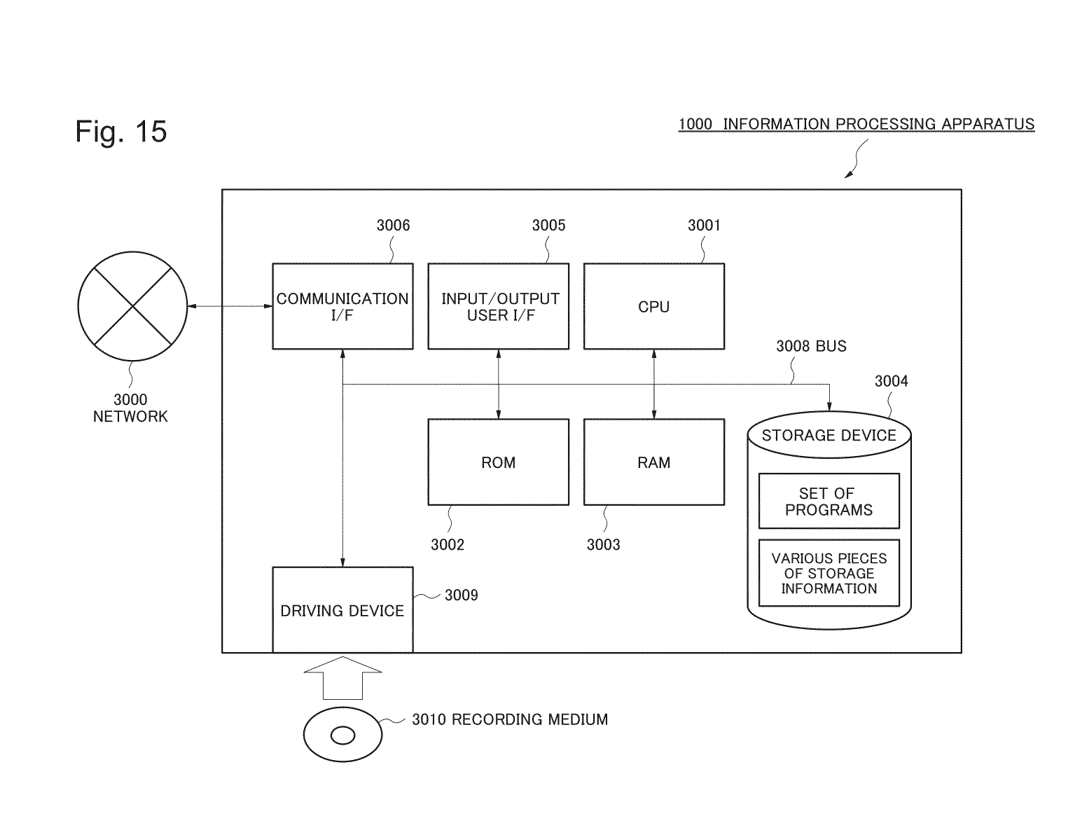

Next, a transportation expense applying server 20a according to a third exemplary embodiment of the present invention will be described. As shown in FIG. 14, the transportation expense applying server 20a includes a communication unit 21a, a transportation expense DB 23a, a storage unit 24a, and a control unit 25a.

The transportation expense DB 23a stores therein transportation expenses between every two of a plurality of places which are determined in advance.

When a terminal has entered any one of the plurality of places, the communication unit 21a receives entrance information including information for identifying the entrance and information for identifying the place, as well as terminal identification information for identifying the terminal; while, when the terminal has exited any one of the plurality of places, the communication unit 21a receives exit information including information for identifying the exit and information for identifying the place, as well as terminal identification information for identifying the terminal.

The storage unit 24a stores therein the entrance information and the terminal identification information, which have been received, such that these two kinds information are related to each other, as well as the exit information and the terminal identification information, which have been received, such that these two kinds information are related to each other.

After the storage of an exit information, when having stored entrance information such that the entrance information is related to the same piece of terminal identification information as that related to the exit information, the control unit 25a determines transportation expenses between two places of the plurality of places, each of the two places being identified by using a corresponding one of the entrance information and the exit information by referring to the transportation expenses DB on the basis of the entrance information and the exit information, and transmits a transportation expense application notification for applying for payment of the determined transportation expenses to an accounting server.

According to this third exemplary embodiment, through reference to the transportation expenses DB 23, the transportation expense applying server 20a determines transportation expenses between two business offices which are identified on the basis of the entrance information and the exit information. Thus, according to this exemplary embodiment, it becomes possible to efficiently apply for payment of transportation expenses having been incurred in a movement between business offices without cooperating with any apparatus installed in means of transportation.

### Modification Examples of the Exemplary Embodiments of the Present Invention

Hereinbefore, the present invention has been described with reference to some exemplary embodiments, but the present invention is not limited to the aforementioned exemplary embodiments. Various changes understandable by those skilled in the art can be made on the configuration and details of the present invention within a scope of the present invention.

For example, in the aforementioned exemplary embodiment, it has been described that the exit information and the entrance information which have been used for a determination of transportation expenses are deleted from the temporary storage unit 24. Further, it has been described that entrance information having been stored before the storage of a related set of entrance information is also deleted from the temporary storage unit 24.

With respect to the exit information, however, there is a case where, after having exited a business office, a company member does not enter any other business office (for example, a case where the company member directly returns home). In this case, unnecessary pieces of exit information remain stored in the temporary storage unit 24 and, as a result, a storage capacity of the temporary storage unit 24 becomes insufficient.

As methods for preventing the occurrence of a situation in which such unnecessary pieces of exit information make a storage capacity of the temporary storage unit 24 insufficient, the following first to three methods can be considered.

### First Method

When a predetermined period of time has elapsed in a state in which an exit information stored in the temporary storage unit 24 remains unused in any determination of transportation expenses, the control unit 25 of the transportation expense applying server 20 deletes this set of exit information from the temporary storage unit 24. It can be considered that the predetermined period of time is made, for example, a period of time resulting from adding a constant period of time to the largest one of periods of time each required for a movement from a business office identified by using the exit information to a corresponding one of the other business offices.

### Second Method

The terminal DB 22 of the transportation expense applying server 20 registers therein location information relating to a residence of a company member who carries the terminal 10. The control unit 14 of the terminal 10 transmits current location information relating to the terminal 10 itself, as well as terminal identification information relating to the terminal 10, to the transportation expense applying server 20. The control unit 25 of the transportation expense applying server 20 refers to the terminal DB 22 on the basis of the current location information relating to the terminal 10, and thereby determines whether the current location of the terminal 10 is positioned within a predetermined range from the location of the residence of the company member who carries the terminal 10. When the current location of the terminal 10 is positioned within the predetermined range therefrom, the control unit 25 determines that the company member has returned home and will not move to any other business office, and deletes the exit information having been stored so as to be related to the terminal identification information relating to the terminal 10 from the temporary storage unit 24.

In addition, the location to be registered in the terminal DB 22 is not limited to the location of such a residence of a company member who carries the terminal 10, and is sufficient if it indicates a specific movement destination, such as a relative's home or a friend's home of the company member who carries the terminal 10. This configuration also makes it possible for the control unit 25 to, when the company member has moved to a location of such a specific movement destination, determine that the company member will not move to any other business office.

### Third Method

Each of company members enables the location information acquisition function of the location information acquisition unit 13 of the terminal 10 only when the company member moves between any two of the business offices. Through this method, when the company member returns home, any set of exit information is not transmitted from the terminal 10 in the first exemplary embodiment, and any piece of current location information is not transmitted from terminal 10 in the second exemplary embodiment. Thus, any set of exit information is not stored in the temporary storage unit 24.

Further in the aforementioned exemplary embodiments, it is supposed that just one movement rout exists between every two of the business offices, and accordingly, in the transportation expense DB 23 of the transportation expense applying server 20, for every two of the business offices, just a kind of transportation expenses is registered. In the case where, however, for example, there are two or more stations near a business office, an office-to-office movement rout to such a business office differs depending on which of the stations is utilized, and further, transportation expenses differ in accordance with a utilized movement route. Thus, in the case where there exist a plurality of movement routes between certain two of the business offices, the following method may be employed.

In the transportation expense DB 23, kinds of transportation expenses, each of the kinds being associated with a corresponding one of the plurality of movement routes, are registered in advance. In addition, an external server is utilized as the transportation expense DB 23, and transportation expenses may be acquired through communication with this server via a network. The control unit 25 determines kinds of transportation expenses each associated with a corresponding one of the plurality of movement routes. The control unit 25 generates a transportation expense confirmation request notification TN including information indicating the determined kinds of transportation expenses, each associated with a corresponding one of the plurality of movement routes, and transmits it to the terminal 10 to make a request for a selection and a confirmation of one of the kinds of transportation expenses. Further, when having received a transportation expense approval notification for notifying the selection of one of the kinds of transportation expenses and an approval of the selected kind of transportation expenses, from the terminal 10, the control unit 25 applies for payment of the kind of transportation expenses having been selected by the terminal 10 with the accounting server 30.

In the aforementioned exemplary embodiments, it is supposed that every time the control unit 25 of the transportation expense applying server 20 determines transportation expenses, the control unit 25 transmits a transportation expense confirmation request notification TN to the terminal 10, but the present invention is not limited to this configuration. The control unit 25 may make confirmation requests each on transportation expenses having been incurred in a corresponding one of a plurality of movements by unifying the confirmation requests into a single transportation expense confirmation request notification TN. In this case, the transportation expense confirmation request notification TN is transmitted at a predetermined timing point, such as the end of every month.

In the aforementioned exemplary embodiments, it is supposed that terminal identification information for identifying each of the terminals 10 is an IMEI, an IMSI or the like, but the present invention is not limited to these terminal identifications. The terminal identification information for identifying each of the terminals 10 is sufficient if it is information capable of identifying each of the terminals 10, such as a telephone number or a mail address.

Further, in the aforementioned exemplary embodiments, description has been made by way of an example in which the present invention is applied to a case where, in a company having a plurality of business offices, company members move among the plurality of business offices. The present invention, however, is not limited to this configuration and can be applied to a case where a user moves between any two of predetermined places. In this case, in substitution for the business office DB, a place DB in which pieces of location information each indicating a location of the plurality of predetermined places are registered is provided, and in the transportation expense DB, pieces of information each indicating transportation expenses between corresponding two of the plurality of predetermined places are registered.

For example, it is supposed that a company, in which there is only one business office, has a customer company members often visit. In this case, the utilization of the present invention makes it possible to apply for payment of transportation expenses having been incurred in a visit to the customer, merely by registering location information indicating a location of the customer into the place DB in advance, and registering transportation expenses which are incurred in a movement from the business office to the customer into the transportation expense DB in advance.

Further, in the aforementioned second exemplary embodiment, the transportation expense applying server 20 and the location information server 50 are provided separately with each other, but the location information server 50 may be unified with the transportation expense applying server 20 by implementing the function of the location information server 50 in the transportation expense applying server 20.

Further, the methods performed by the transportation expense applying server 20 and the like according to the present invention may be applied to a program which causes a computer to carry out the methods. The program can be stored in a storage medium, and can be also provided to the outside via a network.

The transportation expense applying server 20 (20a), the location information server, and the accounting server according to the aforementioned exemplary embodiments can be also realized by utilizing an information processing apparatus (a computer). In this case, at least the control unit 25 (25a) of the individual portions of the transportation expense applying server shown in each of FIGS. 4 and 14 as well as at least the control unit 53 of the location information server 50 shown in FIG. 12 can be deemed as a function (process) unit (a software module) of a software program. An example of a hardware environment which enables realization of each of these functions (processes) will be described with reference to FIG. 15. In this regard, however, individual sectioned portions illustrated in the drawings is just a configuration for the sake of convenience of description, and in an actual implementation, various configurations are assumed.

FIG. 15 is a diagram that illustrates an example of a configuration of an information processing apparatus 1000 which can serve as each of the transportation expense applying server 20 (20a) and the location information server 50, according to the exemplary embodiments of the present invention.

The information processing apparatus 1000 shown in FIG. 15 is a general computer in which the following components are electrically connected to one another via a bus (communication line) 3008.

A central processing unit (CPU) 3001

A read only memory (ROM) 3002

A random access memory (RAM) 3003

A storage device 3004

An input/output user interface (I/F) 3005

A communication interface (I/F) 3006 with external devices

A driving device 3009

The communication I/F 3006 corresponds to the communication unit 21, the communication unit 21a, and the communication unit 51 which are shown in FIG. 4, FIG. 14, and FIG. 12, respectively. The driving device 3009 reads out, from the recording medium 3010, pieces of software (programs), each causes the information processing apparatus 1000 to serve as a corresponding of the transportation expense applying server 20 (20a) and the location information server 50.

Further, under such a hardware environment as described above, the aforementioned exemplary embodiments can be achieved by the following procedure. That is, a computer program capable of realizing the function of the configuration shown in each of the block diagrams (FIGS. 4, 14, and 12) having been referred to in the description of the above exemplary embodiments, or a computer program capable of realizing the processing shown in each of the flowcharts (FIGS. 9 and 13) having been referred to in the description of the above exemplary embodiments, is supplied to the information processing apparatus 1000 via a network 3000 or the driving device 3009. Thereafter, the computer program is read out, interpreted, and executed by the CPU 3001 included in the hardware environment. Further, the computer program having been supplied to the inside of the information processing apparatus 1000 should be stored in a readable/writable volatile storage device (the RAM 3003) or a non-volatile storage device, such as the storage device 3004.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

### REFERENCE SIGNS LIST

10: terminal

11: communication unit

12: business office DB

13: location information acquisition unit

14: control unit

20 and 20a: transportation expense applying server

21 and 21a: communication unit

22: terminal DB

23: transportation expense DB

24: temporary storage unit

24a: storage unit

25 and 25a: control unit

30: accounting server

40: network

50: location information server

51: communication unit

52: business office DB

53: control unit

1. A transportation expense applying server comprising:
a communication unit that
receives entrance information including information for identifying that a terminal has entered one of a plurality of places, information for identifying a place the terminal has entered, and terminal identification information for identifying the terminal
receives exit information including information for identifying that the terminal has exited one of the plurality of places and information for identifying the place the terminal has exited, and the terminal identification information;
a storage unit that stores the entrance information and the exit information relating to the terminal identification information received therewith; and
a control unit that after storing the exit information, when storing the entrance information related to the terminal identification information which is identical to the terminal identification information related to the exit information,
refers to a transportation expense database which stores transportation expenses between/among the specific multiple locations, based on the entrance information and the exit information,
determines the transportation expenses between/among locations identified respectively by the entrance information and the exit information, and
sends a transportation expenses application notification applying for the determined transportation expenses to an accounting server.

2. The transportation expense applying server according to claim 1, wherein,
when having determined the transportation expenses, the control unit transmits, to the terminal, a transportation expense confirmation notification which includes information indicating the determined transportation expenses, as well as the entrance information and the exit information which have been used for determining the transportation expenses, the transportation expense confirmation notification requesting for confirmation of the transportation expenses, and
after having received a transportation expense approval notification for notifying an approval of the determined transportation expenses from the terminal, the control unit transmits the transportation expense application notification to the accounting server.

3. A transportation expense applying system comprising:
a terminal that is carriable by a user who travels between/among a plurality of specific places;
a transportation expense applying server that applies for transportation expenses occurred during the user's traveling between/among the plurality of specific places; and
an accounting server that is applied for the transportation expenses,
wherein the terminal
includes a place database in which locations each corresponding one of the plurality of places are registered,
acquires location information indicating a current location of the terminal,
determines whether or not the terminal has entered any one of the plurality of places as well as whether or not the terminal has exited any one of the plurality of places, by referring to the place database on the basis of the current location of the terminal,
transmits, in response to the terminal's entrance into one of the plurality of places, entrance information including information for identifying the entrance and information for identifying the place where the terminal has entered, and terminal identification information for identifying the terminal, to the transportation expense applying server, and
transmits, in response to the terminal's exit from one of the plurality of places, exit information including information for identifying the exit and information for identifying the place where the terminal has exited, and the terminal identification information, to the transportation expense applying server, and
wherein the transportation expense applying server
includes a storage unit that stores therein the entrance information and the exit information received with the terminal identification information, in state that the entrance information and the exit information are related to the terminal identification information,
after storing the exit information, when storing the entrance information related to the terminal identification information which is identical to the terminal identification information related to the exit information, refers to a transportation expense database which stores transportation expenses between/among the specific multiple locations, based on the entrance information and the exit information,
determines the transportation expenses between/among locations identified respectively by the entrance information and the exit information, and
sends a transportation expenses application notification applying for the determined transportation expenses to an accounting server.

4. A transportation expense applying system comprising:
a terminal that is carriable by a user who travels between/among a plurality of specific places;
a location information server;
a transportation expense applying server that applies for transportation expenses occurred during the user's traveling between/among the plurality of specific places; and
an accounting server that is applied for the transportation expenses,
wherein the terminal
acquires location information indicating a current location of the terminal, and
transmits the acquired location information and terminal identification information for identifying the terminal to the location information server, and
wherein the location information server
includes a place database in which locations each corresponding one of the plurality of places are registered,
determines whether or not the terminal has entered any one of the plurality of places and whether or not the terminal has exited any one of the plurality of places, by referring to the place database on the basis of the current location of the terminal,
transmits, in response to the terminal's entrance into one of the plurality of places, entrance information including information for identifying the entrance and information for identifying the place where the terminal has entered, and terminal identification information for identifying the terminal, to the transportation expense applying server, and
transmits, in response to the terminal's exit from one of the plurality of places, exit information including information for identifying the exit and information for identifying the place where the terminal has exited, and the terminal identification information, to the transportation expense applying server, and
wherein the transportation expense applying server
includes a storage unit that stores therein the entrance information and the exit information received with the terminal identification information, in state that the entrance information and the exit information are related to the terminal identification information,
after storing the exit information, when storing the entrance information related to the terminal identification information which is identical to the terminal identification information related to the exit information, refers to a transportation expense database which stores transportation expenses between/among the specific multiple locations, based on the entrance information and the exit information,
determines the transportation expenses between/among locations identified respectively by the entrance information and the exit information, and
sends a transportation expenses application notification applying for the determined transportation expenses to an accounting server.

5. The transportation expense applying system according to claim 3, wherein,
when having determined the transportation expenses, the control unit transmits, to the terminal, a transportation expense confirmation notification which includes information indicating the determined transportation expenses, as well as the entrance information and the exit information which have been used for determining the transportation expenses, the transportation expense confirmation notification requesting for confirmation of the transportation expenses, and
after having received a transportation expense approval notification for notifying an approval of the determined transportation expenses from the terminal, the control unit transmits the transportation expense application notification to the accounting server.

6. The transportation expense applying system according to claim 3,
wherein the transportation expense database stores a plurality of traveling routes if the plurality of traveling routes exist between/among the plurality of specific places,
wherein the transportation expense applying server
determines each of transportation expenses relating to each of the traveling routes,
transmits, to the terminal, a transportation expense confirmation notification which includes information indicating each of the determined transportation expenses relating to each of the traveling routes, as well as the entrance information and the exit information which have been used for determining the transportation expenses, the transportation expense confirmation notification requesting for selection and confirmation of the transportation expenses, and
after receiving a transportation expenses approval notification which indicates the selected transportation expense is approved, sending the transportation expenses application notification applying for the selected transportation expense to an accounting server.

7. The transportation expense applying system according to claim 5, wherein the transportation expense applying server deletes the entrance information and the exiting information which have been used for determining the transportation expenses from the storage unit.

8. The transportation expense applying system according to claim 7, wherein, when a specific period of time has elapsed in a state that the exit information remains in the storage unit without used for determining the transportation expenses, the transportation expense applying server deletes the exit information from the storage unit.

9. The transportation expense applying system according to claim 7,
wherein the transportation expense applying server further includes a terminal database in which location information indicating a specific traveling destination relating to a user who carries the terminal is registered, the location information is related to the terminal identification information for identifying the terminal, and
wherein the terminal transmits location information indicating a current location of the terminal and the terminal identification information to the transportation expense applying server, and
wherein the transportation expense applying server
determines whether or not the terminal has traveled to the specific destination, by referring to the terminal database on the basis of the current location of the terminal, and
in response to the terminal's traveling to the specific destination, deletes the exit information stored in the storage unit in a state of being related to the terminal identification information for identifying the terminal.

10. The transportation expense applying system according to claim 7, wherein the terminal's function for acquiring location information indicating a current location of the terminal is enabled during the terminal's traveling between/among the plurality of places.

11. A transportation expense applying method performed by a transportation expense applying server, comprising:
receiving entrance information including information for identifying that a terminal has entered one of a plurality of specific places and information for identifying the place the terminal has entered, as well as terminal identification information for identifying the terminal;
storing the exit information relating to the terminal identification information received therewith;
receiving exit information including information for identifying that the terminal has exited one of the plurality of specific places and information for identifying the place the terminal has exited, as well as the terminal identification information;
storing the exit information relating to the terminal identification information received therewith;
after storing the exit information, when storing the entrance information related to the terminal identification information which is identical to the terminal identification information related to the exit information, referring to a transportation expense database which stores transportation expenses between/among the specific multiple locations, based on the entrance information and the exit information,
determining the transportation expenses between/among locations identified respectively by the entrance information and the exit information, and
sending a transportation expenses application notification applying for the determined transportation expenses to external.

12. The transportation expense applying method according to claim 11, wherein, when having determined the transportation expenses,
transmitting, to the terminal, a transportation expense confirmation notification which includes information indicating the determined transportation expenses, as well as the entrance information and the exit information which have been used for determining the transportation expenses, the transportation expense confirmation notification requesting for confirmation of the transportation expenses, and
after having received a transportation expense approval notification notifying an approval of the determined transportation expenses from the terminal, transmitting the transportation expense application notification to the external.

13. A computer-readable non-temporary recording medium that stores therein a program which causes a computer to execute processing, the processing comprising:
receiving entrance information including information for identifying that a terminal has entered one of a plurality of specific places and information for identifying the place the terminal has entered, as well as terminal identification information for identifying the terminal;
storing the exit information relating to the terminal identification information received therewith;
receiving exit information including information for identifying that the terminal has exited one of the plurality of specific places and information for identifying the place the terminal has exited, as well as the terminal identification information;
storing the exit information relating to the terminal identification information received therewith;
after storing the exit information, when storing the entrance information related to the terminal identification information which is identical to the terminal identification information related to the exit information, referring to a transportation expense database which stores transportation expenses between/among the specific multiple locations, based on the entrance information and the exit information;
determining the transportation expenses between/among locations identified respectively by the entrance information and the exit information; and
sending a transportation expenses application notification applying for the determined transportation expenses to external.

14. The recording medium according to claim 13, the processing further comprising:
transmitting, to the terminal, a transportation expense confirmation notification which includes information indicating the determined transportation expenses, as well as the entrance information and the exit information which have been used for determining the transportation expenses, the transportation expense confirmation notification requesting for confirmation of the transportation expenses, and
after having received a transportation expense approval notification notifying an approval of the determined transportation expenses from the terminal, transmitting the transportation expense application notification to the external.
